(19) United States
(12) Patent Application Publication
(10) Pub. No.: US 2003/0159607 A1
(43) Pub. Date: Aug. 28, 2003

(54) Method for the preparation of lithographic printing plates

(76) Inventors: Boaz Nitzan, Ganey-Tikva (IL); Moshe Frenkel, Jerusalem (IL)

Correspondence Address: Edward Langer, Shiboleth Yisraeli Roberts Zisman & Company, 60th Floor, 350 Fifth Avenue, New York, NY, 10118, US

(21) Appl. No.: 10/169,061

(22) PCT Filed: Jan. 4, 2001
(86) PCT No.: PCT/IL01/00012

(51) Int. Cl. B41C 1/10; B41N 1/08

(52) U.S. Cl. 101/466

(57) ABSTRACT

A simple and inexpensive method for the direct preparation of offset lithographic printing plates using computer-to-plate methods and an inkjet marking fluid jetted directly onto a printing surface by conventional inkjet systems. The marking fluid is a two-phase emulsion system, comprising an oleophilic inner phase and a continuous, aqueous, external phase. To effectively control the dot size in the image to he printed and advantageously produce long runs of good-quality impressions from printing on a conventional offset lithographic press, the viscosity of the marking fluid used is preselected, and a very thin cationic surfactant coating is applied to the printing surface. Alternatively, a marking fluid having a pre-selected viscosity is used together with a cationic surfactant coating solution applied directly to a printing surface in a plateless lithographic printing system.

### FIELD OF THE INVENTION

The present invention generally relates to the preparation of printing plates using computer-to-plate (CTP) methods involving inkjet printing, and more particularly, to an offset plate coating material and an inkjet marking fluid and a method for their use in direct CTP preparation of offset lithographic printing plates.

### BACKGROUND OF THE INVENTION

Offset lithographic printing has been a popular method of printing for many years, primarily because of the relative ease with which printing plates can be produced. Currently, the most widely-used method for plate preparation has remained that which utilizes specially-prepared masking films through which pre-sensitized printing blanks are selectively hardened or softened—according to the chemistry of the plate—by exposure to ultra-violet light. The plate then undergoes a development process, during which the more soluble regions of the plate are washed away. A detailed description of a typical system and the plates used is found in Chapter 20 of the book entitled: Printing Materials: Science and Technology, by Bob Thompson (Pira Int., Leatherhead, Surrey, UK, 1998).

In recent years, various considerations have arisen that point to advantages for modification of hitherto generally-accepted practices. With the advent of computers, information for printing is prepared digitally and it has become preferable to use this digital information as directly as possible in plate preparation. One obvious way would be to eliminate the masking film. Not only are these films a source of expense, but the most widely used films are based on silver chemistry whereby the exposure and handling of the film must be in a light-excluding environment. In addition, the exposed film must be processed with chemical solutions which are unstable, messy, and environmentally problematic. One answer is to be found in computer-to-plate (CTP) systems whereby the offset lithographic plates are directly imaged with a light source which is modulated to correspond to the digital information from the computer. Thus the film intermediate is completely eliminated. In general, such plates still need processing by solution, although attempts are being made to develop CTP systems that are processless. A more-detailed description of the subject of CTP systems is found in Chapter 21 of the above-cited book (Thompson, op. cit.).

In U.S. Pat. No. 5,339,737, Lewis, et al, describe the processless preparation of offset lithographic printing plates, wherein the upper layer or layers of the plate are removed by ablation. The upper layer is either oleophobic for waterless plates or hydrophilic for conventional, wet-process plates. The substrate is oleophilic in both cases. Another patent similar to the previous one is U.S. Pat. No. 5,353,705 by Lewis, et al, but this patent describes additional layers for secondary, partial ablation. Yet another patent utilizing ablation is U.S. Pat. No. 5,487,338, but it includes the use of reflective layers. All of these prior art inventions involve multiple-layered plates which are expensive and time-consuming to produce. Also, it is more difficult to maintain a consistent standard of quality from plate to plate. Moreover, they utilize laser imaging systems which are in themselves costly. Due to these disadvantages, the prior art inventions do not address the needs of many small-to-medium-sized enterprises.

A plate-making process is required which has the utmost simplicity, eliminates all chemical processing, and can be effected at a minimal cost for the plate production and for associated equipment. The process should also be rapid.

Inkjet printing is a non-impact, digital-printing method which allows images to be produced and printed under computer control. Inkjet ink is jetted through very fine nozzles and the resultant ink droplets form an image directly on a substrate. There are two main types of inkjet processes. In one process, usually termed “continuous inkjet printing”, a stream of ink drops is electrically charged and then is deflected by an electric field, either directly or indirectly, onto a substrate. The viscosity of inks used in such systems is typically 2 or 3 centipoise. In the second process, usually called “drop on demand” (DOD) inkjet printing, the ink supply is regulated by an actuator such as a piezoelectric actuator of the type used in the Trident Ultrajet Printhead. The pressure produced during the actuation forces a droplet through a nozzle onto the substrate. Inks for DOD inkjet printing do not need to be conductive and their viscosity is typically between 2 and 40 centipoise.

The prior art shows several examples of the application of inkjet printing principles to the preparation of offset lithographic printing plates.

In U.S. Pat. No. 4,833,486 by Zerillo, a hydrophobic, solid, inkjet ink—also called a phase-change inking medium—contains waxes held at a sufficiently high temperature to jet the ink through a DOD head. This solid, phase-change ink technology is more fully-described in U.S. Pat. Nos. 4,390,369, 4,484,948, and 4,593,292. The substrate is a hydrophilic offset plate—either paper or aluminum—onto which the ink is jetted to form an image. When the ink hits the plate it immediately cools and solidifies. One problem, and a serious drawback, of such an approach is the difficulty of obtaining sufficiently good adhesion to the plate of the wax in the ink medium to run multiple impressions during lithographic printing.

European Patent EP503621, owned by Nippon Paint Co., describes two approaches. One approach describes jetting inks onto a presensitized plate which then needs further treatment, including a developing stage with a liquid developer. The other approach uses a non-presensitized plate and the inkjet ink is photosensitive so that it can be hardened onto the plate.

European Patent EP533168, owned by Nippon Paint Co., describes the use of a photopolymeric-based inkjet ink together with an ink-absorbing layer on the lithographic plate surface.

European Patent EP697282, to Leanders and owned by Agfa, describes a two-component system whereby one reactive component is in the ink and the other in the lithographic plate surface so that when the ink hits the plate it produces an-oleophilic, reduced silver image that can be used in the offset printing process.

In U.S. Pat. No. 5,495,803 to Gerber and owned by Gerber Scientific Products, Inc., a coated, presensitized plate is imaged with a UV-opaque, hot-melt, inkjet ink and the ink is used as a photomask to expose the plate. The unexposed presensitized polymer and the ink are subsequently removed by washing.

In U.S. Pat. No. 5,738,013 to Kellet, an inkjet plate-making process is described which involves the use of a reactive inkjet ink which is bonded to the lithographic plate by a chemical reaction activated by radiant energy. This assumes that such inks have very good stability at room temperature so that no ink passing through the nozzles of the inkjet will be blocked. Moreover, it is assumed that the ink will have good reactivity at high temperatures so that the ink becomes insoluble with good adhesion to the offset plate and with good oleophilic properties.

Thus, while there have b(en prior art attempts to use the inkjet process for direct imaging of plates, difficulties have remained in producing satisfactory quality and run lengths while maintaining reasonable costs and operating times. Both water-based and solvent-based inks have problems of spreading of the ink on the high surface-energy, hydrophilic plate surface due to the properties needed to jet the ink. Phase-change inks have problems with bonding of the wax-like ink to the plate. In addition, there is the need to eliminate further liquid processing and to provide a simple process of plate production, or, to eliminate the plate component altogether and directly image a lithographic press printing surface.

### SUMMARY OF THE INVENTION

Accordingly, it is a principal object of the present invention to overcome the disadvantages associated with prior art computer-to-plate methods, by providing a simple and inexpensive method of producing an offset lithographic printing plate by means of the inkjet process. The method uses a novel inkjet fluid that, while giving excellent jetting properties with high consistency and quality, can be easily dried on an uncoated or coated lithographic printing plate.

In accordance with a preferred method of the present invention, there is provided a method for the direct CTP preparation of a printing plate, said method comprising the steps of:

providing a digital image by means of a computer system;

providing an inkjet marking fluid having a pre-selected viscosity, wherein said marking fluid is comprised of a two-phase emulsion system consisting of an oleophilic inner phase and a continuous, aqueous, external phase;

jetting said marking fluid onto a printing surface; and

drying said marking fluid onto said printing surface.

In the preferred method, inkjet marking fluid is deposited in a pattern that is digitally-determined to provide the information directly from a computer to a plate. In accordance with the inventive method, the dot size of the inkjet fluid deposited on the printing surface of an offset printing press is controlled by controlling the viscosity of the fluid, thus achieving excellent control over the quality of the image to be printed.

A further embodiment of the method of the present invention comprises the additional steps, prior to the jetting step, of providing a cationic surfactant coating solution; applying said coating solution to said printing surface; and drying said coating solution on said printing surface.

These further steps provide additional control of the dot size of the inkjet marking fluid deposited on a printing surface in accordance with the method of the present invention. Although the printing surface can be any material known to the art, in the preferred embodiment, the surface is an aluminum offset plate. By controlling the type and concentration of the active component in the cationic surfactant coating applied to a printing surface, prior to printing of said plate, the dot size of the marking fluid can be more effectively controlled to produce long runs of good-quality impressions from printing on a conventional offset lithographic press.

In yet another method, the novel inkjet marking fluid, as well as the surfactant coating solution, can be used directly in a plateless lithographic printing system to form a strong, stable, oleophilic image from which large quantities of good-quality impressions can be printed.

Other features and advantages of the present invention will become clear from the further detailed description and examples.

### BRIEF DESCRIPTION OF THE DRAWINGS

For a better understanding of the invention with regard to the embodiments thereof, reference is made to the accompanying drawings (not to scale), in which like numerals designate corresponding elements or sections throughout, and in which:

FIGS. 1a, 1b, and 1c show enlarged sectional views of a typical, multi-layered offset lithographic printing plate, as known in the prior art, depicting the process of imaging said plate using UV light.

FIGS. 2a, 2b, and 2c show enlarged sectional views of a typical, multi-layered offset lithographic printing plate, as known in the prior art, depicting the process of imaging said plate using an infra-red laser ablation process;

FIG. 3 shows a computer-to-plate inkjet system, wherein is shown the drop-wise deposition of inkjet marking fluid from an inkjet printing head onto a printing plate in accordance with the present invention;

FIG. 4 shows a computer-to-plate inkjet system, depicting an offset lithographic plate, prepared in accordance with the present invention, mounted onto an offset printing press;

FIG. 5 shows another embodiment of the method of the present invention, wherein the image to be formed is provided by the direct deposition of inkjet marking fluid onto a lithographic printing cylinder in a plateless system; and

FIG. 6 shows enlarged sectional views of a series of steps in yet another embodiment of the method of the present invention, wherein the image to be formed is provided by the direct deposition of inkjet marking fluid onto the substrate of a coated lithographic printing plate, said coating comprising a very thin layer of cationic surfactant solution.

### DETAILED DESCRIPTION OF THE INVENTION

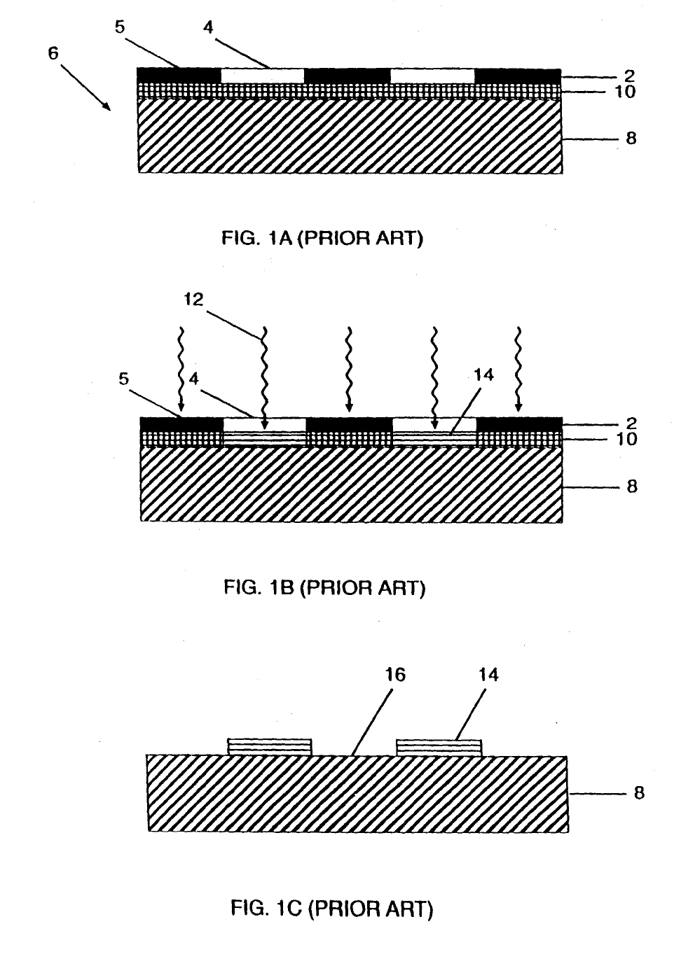

Referring now to FIGS. 1a, 1b, and 1c, there is shown an example of the steps in the widely-used prior art process of plate-making with presensitized plates.

FIG. 1a shows a film 2 which contains, in negative form, the image areas 4 to be printed. Presensitized printing plate 6 is comprised of a grained, anodized aluminum substrate 8 and coated with a photopolymeric layer 10, which is comprised of a photosensitive pre-polymer and a carrier resin. Film 2 is placed in emulsion-to-emulsion contact with presensitized plate 6 and, as shown in FIG. 1b, is flood-irradiated with ultraviolet light 12. Transparent areas 4 of negative film 2, which represent the image areas to be printed, permit the penetration of UV light 12 to photopolymeric layer 10 which reacts to form hard, insoluble oleophilic areas 14. The black areas 5 of negative film 2, which correspond to the background areas of the print, prevent UV light 12 from penetrating and thus portions of photosensitive layer 10 remain in the pre-polymer state. Negative film 2 is then removed and plate 6 is processed—usually with a high pH aqueous solution in which the unpolymerized portions of layer 10 are readily soluble. This exposes the grained anodized surface 16 of substrate 8 and provides the hydrophilic background areas for the processed printing plate, as shown in FIG. 1c, now ready to be mounted in a conventional offset lithographic printing press.

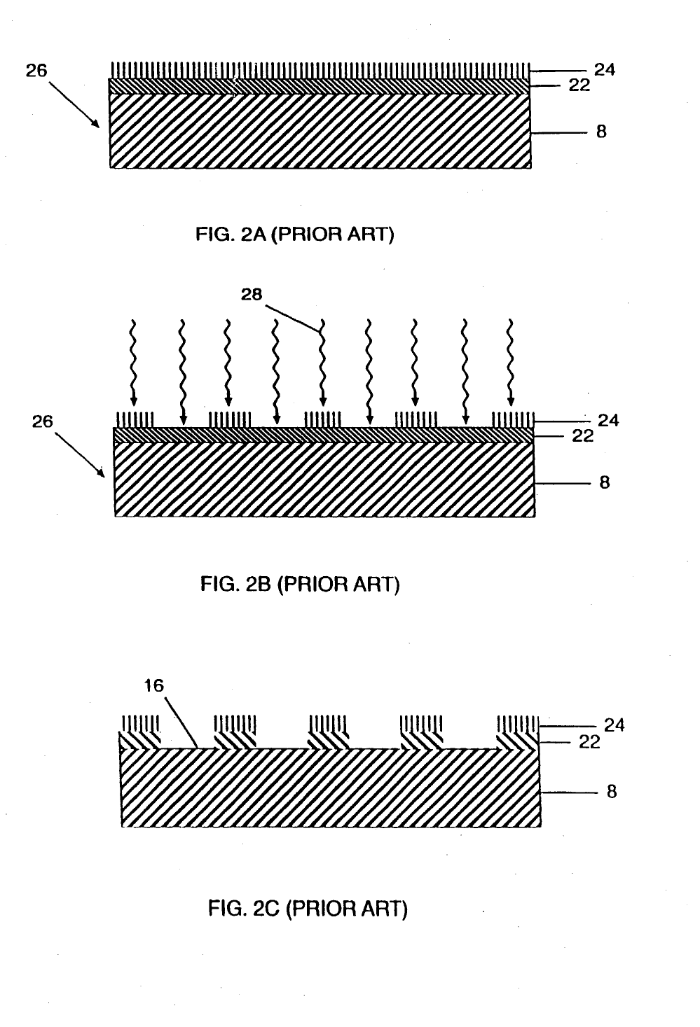

FIGS. 2a, 2b, and 2c show, in an enlarged depiction, the steps in a simplified, infrared-ablatable, computer-to-plate process as known in the prior art. FIG. 2a depicts an unprocessed plate 26 comprising: a substrate 8, which may be, for example, aluminum; an infrared-absorbing layer 22; and a hydrophilic, top coating 24. In FIG. 2b, plate 26 is imaged by digitally-modulated infrared radiation 28 that is absorbed by layer 22. The energy absorbed causes an extremely fast rise in temperature resulting in ablation of layer 22 which takes with it portions of the hydrophilic coating 24. FIG. 2c shows the resulting plate with portions of coating 24 providing the oleophilic image areas of plate 26 and the exposed portions of surface 16 of substrate 8 providing the hydrophilic background portions of plate 26.

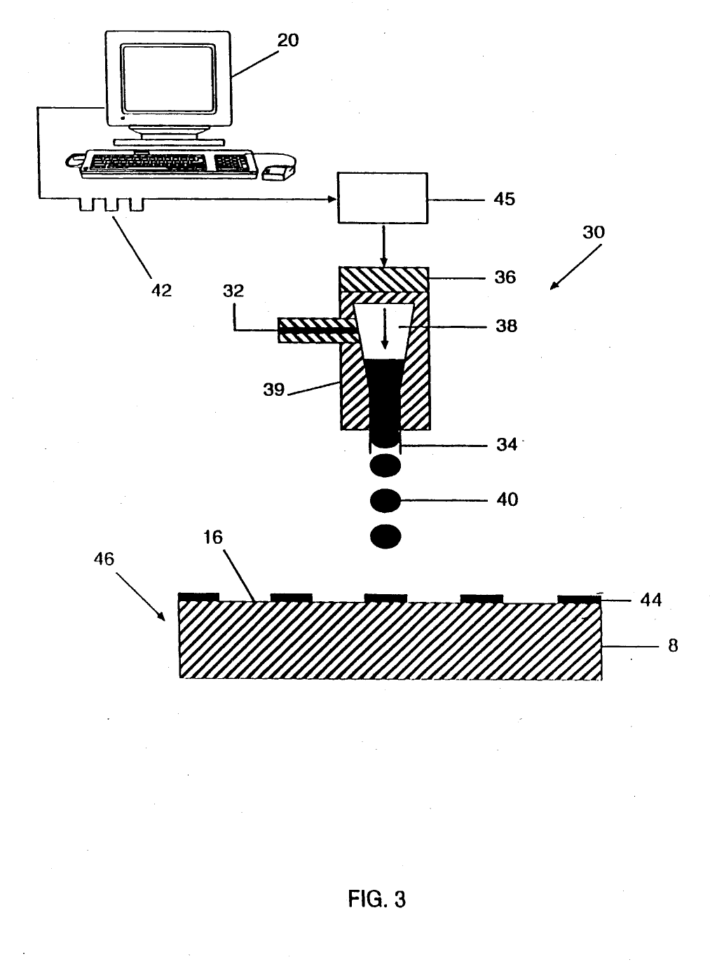

Referring now to FIG. 3, there is shown a computer-to-plate inkjet printing system 30, constructed and operated in accordance with the principles of the present invention. Using a computer 20, a data pulse train 42 is generated which activates a transducer 45. Transducer 45 emits an electrical signal which actuates a piezo-electric crystal 36. Crystal 36 produces a pressure wave inside ink chamber 38 causing inkjet fluid 32 in ink chamber 38 to be ejected in a stream of droplets 40 through inkjet printer nozzle 34 onto surface 16 of a typical printing plate substrate 8. Substrate 8 may be any type of substrate known to the art from which offset lithographic plates are fabricated, but in the preferred embodiment, it is aluminum-based with a grained, anodized, hydrophilic surface. Although any type of inkjet system is useful in the present invention, in FIG. 3 is shown a generic impulse, drop-on-demand system, as this is the preferred system of the invention. As the inkjet head 39 traverses surface 16, a pattern of dots 44, forming the image to be printed, is deposited on surface 16 of substrate 8. After fluid deposition, substrate 8 is heated by any means known to the art to evaporate any water in the fluid and to fuse the resins onto substrate 8.

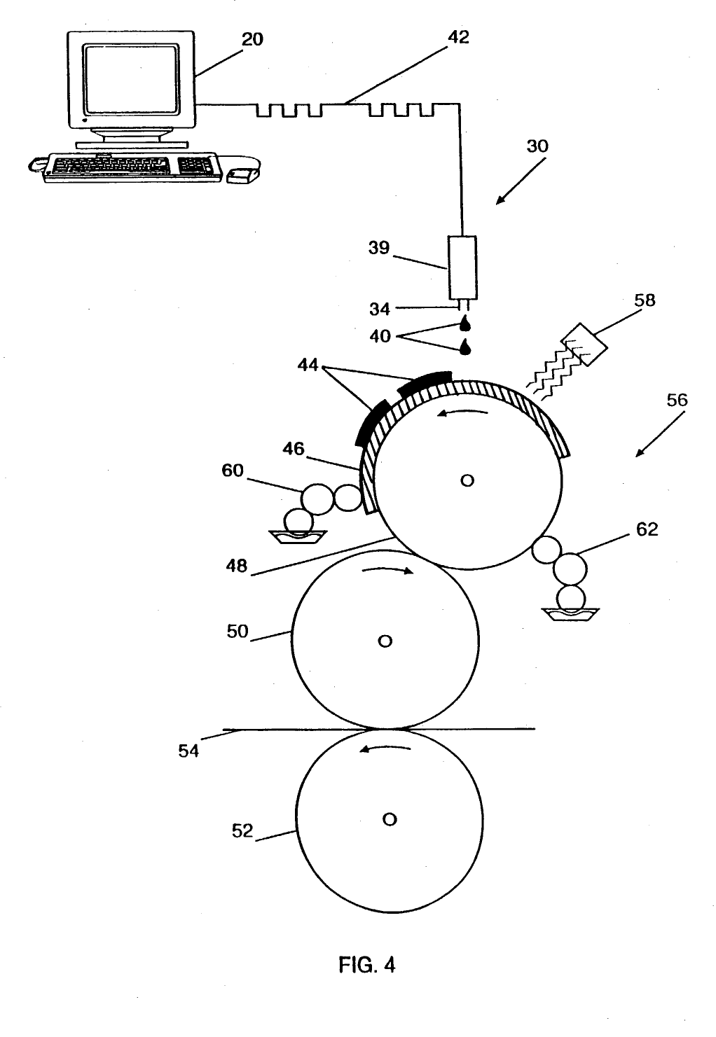

FIG. 4 shows a further embodiment of the method of the present invention, wherein a printing plate 46, is prepared in accordance with the method of the present invention as described above but, in this embodiment, the method is performed by mounting plate 46 onto cylinder 48 of an offset lithographic press 56 used in combination with a CTP inkjet system 30. Inkjet marking fluid is deposited in a pattern that is digitally-determined to provide the information directly from a computer to a plate. A data pulse train 42, generated from computer workstation 20, activates a transducer (not shown) in CTP system 30, which controls the flow of inkjet marking fluid provided through printhead 39, thereby causing said marking fluid to be ejected in a stream of drops 40 through inkjet printer nozzle 34 onto the surface of printing plate 46. Drops 40 produce a pattern of dots 44 as inkjet printhead 39 traverses the surface of plate 46, thus forming an image on the surface of printing plate 46.

After said marking fluid is deposited onto printing plate 46, drying system 58, which may be any drying system known to the art, is used to heat printing plate 46 to evaporate any water remaining on the surface of printing plate 46 and to fuse the resins to the substrate of printing plate 46. Printing plate 46 is then wetted by fountain solution applied by wetting cylinders 60 and the imaged areas are inked by inking cylinders 62 and the image is then transferred to blanket cylinder 50 by rotation of the cylinder press. Thus the inked image is further transferred to paper 54, as it is pressed between blanket cylinder 50 and impression cylinder 52.

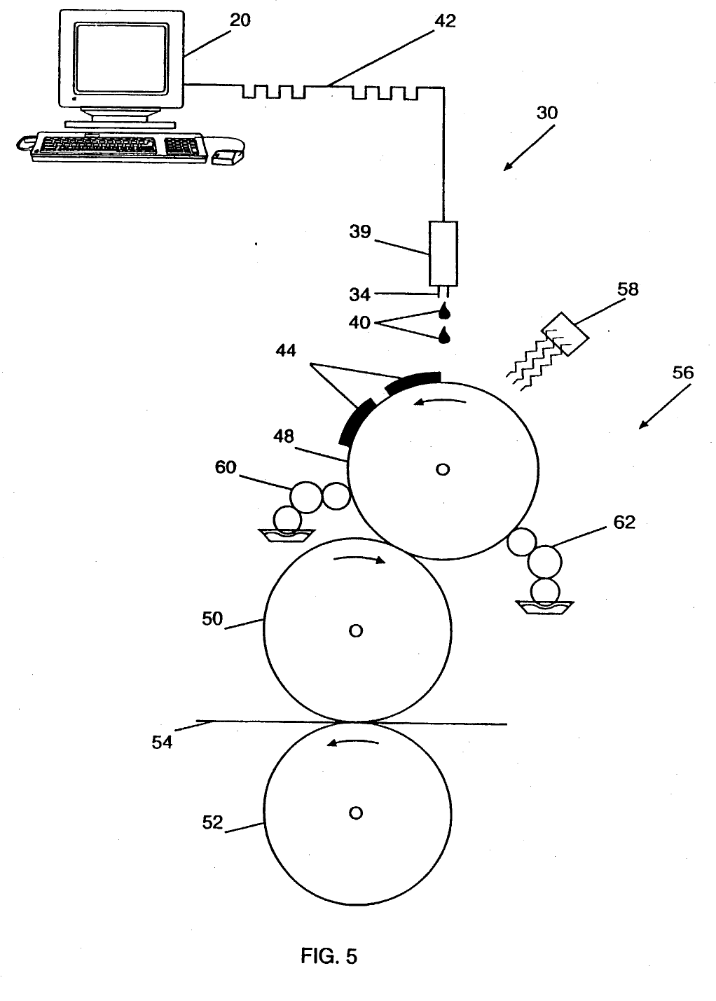

In a further embodiment of the present invention, as is shown in FIG. 5, the printing image is erasable and offset lithographic printing press 56 is plateless. Inkjet system 30 is depicted jetting marking fluid 40 onto the surface of erasable cylinder 48. Erasable cylinder 48 acts as a substrate for the direct deposition of marking fluid drops 40 and is comprised of any type of hydrophilic surface known to the art. In the preferred embodiment, cylinder 48 is comprised of a grained, anodized, aluminum surface. Although any type of inkjet system is useful in this invention, FIG. 5 shows a generic impulse, drop-on-demand system 30, as this is the preferred system.

Using computer 20, a data pulse train 42 is generated which activates a transducer (not shown) embedded in printhead 39. The electrical signal generated, controls the jetting of inkjet marking fluid ejected in a stream of droplets 40 from inkjet printhead 39 via nozzle 34 which produces a pattern of dots 44 as inkjet printhead 39 traverses the surface of erasable cylinder 48. Thus the inkjet marking fluid in the form of drops 44 is deposited in a pattern that is digitally-determined to provide the information directly from computer workstation 20 to erasable cylinder 48 which is plateless. After marking fluid 44 is deposited onto erasable cylinder 48, it is dried by drying system 58, which can be any method of heating as known to the art, to evaporate the water in the fluid and to fuse the resins to the substrate.

In printing, a fount solution is applied to erasable cylinder 48 by wetting cylinder 60 and the imaged areas composed of the pattern of dots 44 are inked by ink cylinder 62 and the image is transferred to blanket cylinder 50 by rotation of the cylinders in lithographic press 56, thus the inked image is transferred to the print surface consisting, in the example shown, of paper 54, which is pressed between the blanket cylinder 50 which receives the inked image and impression cylinder 52. After the printing process, the dried image can be erased either by abrasion or with the aid of an aqueous fluid of either high or low pH or by application of high temperature to decompose the cured image remaining and to clean erasable cylinder 48 which is then ready to accept a new image.

In yet a further embodiment of the method of the present invention, the method of a plateless system of offset printing, as shown in FIG. 5, is greatly improved with the additional steps of directly coating the surface of print cylinder 48 with a cationic surfactant solution, provided and prepared in accordance with the present invention, prior to jetting marking fluid onto the surface of cylinder 48.

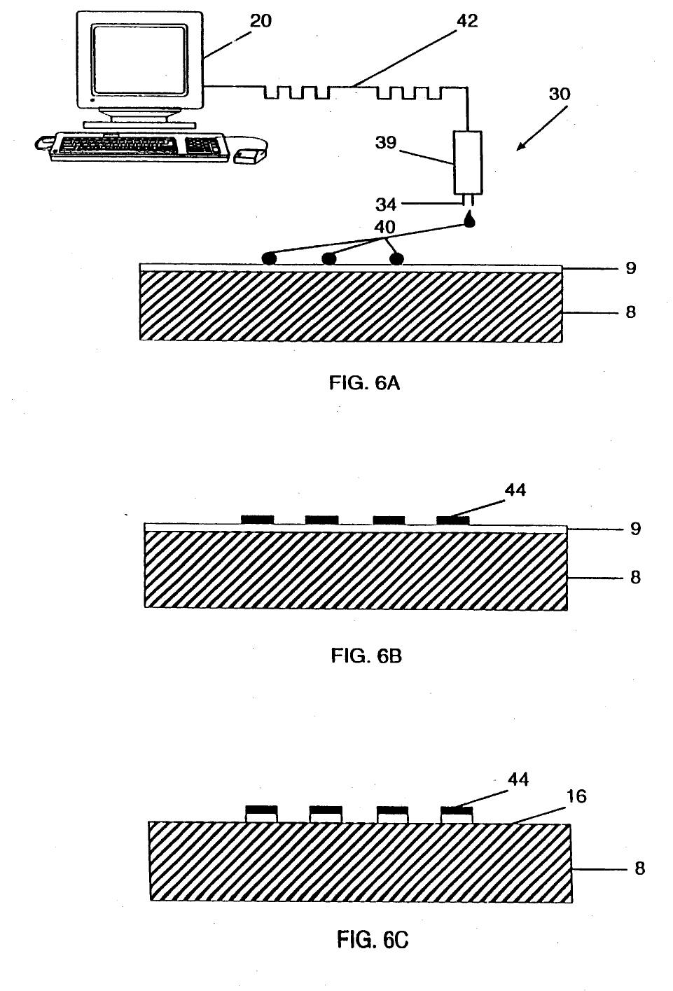

FIG. 6 depicts yet another embodiment of the present invention. FIG. 6A shows a computer-to-plate inkjet printing system 30, constructed and operated in accordance with the principles of the present invention. Using a computer 20, a data pulse train 42 is generated which operates a typical inkjet printer head 39 causing droplets 40 to be ejected in a stream through inkjet printer nozzle 34 onto the surface of a typical printing plate substrate 8. Substrate 8, in accordance with this embodiment, is first immersed in a surfactant solution as herein described in the various embodiments and examples, and thereafter dried so as to form a very thin coating 9 on plate substrate 8 for receiving the marking ink. Substrate 8 may be any type of substrate known to the art from which offset lithographic plates are fabricated, but in the preferred embodiment, it is aluminum-based with a grained, anodized, hydrophilic surface. Although any type of inkjet system is useful in the present invention, FIG. 6A shows a generic impulse, drop-on-demand, system, as this is the preferred system of the invention.

As the inkjet head 39 traverses the coated surface of substrate 8, a pattern of dots 44, forming the image to be printed, is deposited onto the surface of coating 9 as shown in FIG. 6B. After fluid deposition, plate 46 is heated by any means known to the art to evaporate any water in the inkjet marking fluid and to fuse the resins contained therein to coating 9 on substrate 8.

FIG. 6C shows the plate after washing with water to remove any coating 9 which may remain on surface 16 of the exposed substrate 8. The dots 44 of inkjet marking fluid which form the image to be printed are unaffected by washing as they are fused to coated surface 16. The prepared plate is then ready to be mounted in a conventional lithographic printing press for printing.

In accordance with the principles of the present invention, the inkjet medium of the marking fluid is provided in the form of a dispersion since it is known to those conversant with the prior art that true solutions, whether they be water-based, oil-based, or solvent-based, give poor imaged plates because of their tendency to spread over the surface of the plates. The present invention comes to solve this difficulty by utilizing a two-phase fluid comprising a combination of resin dispersion in water. On contact with a printing plate, the outer, aqueous phase of the inkjet fluid is separated from the internal phase by both capillary action onto the hydrophilic plate surface, and by evaporation, leaving the relatively high-viscosity internal phase of the dispersion which coalesces to give a smooth sharp print image on the printing plate.

The preferred embodiment of the invention utilizes an inkjet marking fluid which is based on an internal, dispersion phase and a continuous aqueous, external phase. The particle size of the internal phase is from 4 nm to 3 microns. The inkjet marking fluid in the preferred embodiment is characterized by a viscosity greater than 2 centipoise and less than 40 centipoise, and, more specifically, by a viscosity of between 3 and 25 centipoise. Surface tension of the marking fluid should be within the range of between 28-60 dyne/cm. The amount of polymer binder which constitutes the internal phase of the dispersion should be at least 5% and, in the preferred embodiment, in the range of between 8-20% by weight.

In the preferred embodiment, the internal phase of the dispersion is a polymer selected from the group consisting of urethanes, acrylates, methacrylates, styrene, vinyl acetate and other vinyl esters (e.g., laurate), ethylene, butadiene, vinyl chloride, vinylidene chloride, and copolymers of the above materials.

Other ingredients present in the inkjet fluid are those known to the art. These include humectants, dyes, pigments, cosolvents, and coalescing agents. A preferred additive in these fluids is a water-soluble, low molecular-weight polymer that acts as a surfactant in stabilization of the system and at the same time helps maintain the sharpness of print on the finished, imaged plate. Another preferred type of ingredient is a coalescing agent which is necessary to ensure that the dispersed polymer particles form a smooth image after the image coalesces on the surface of the plate and the water leaves the system. Although some coloration or dye substance is needed in the system so that the image on the plate is visible, in the preferred embodiment, carbon black, which is in itself oleophilic, serves this purpose, but it is limited to a concentration of not greater than 15% by weight in order to optimize the mechanical resistance of the image to the printing process.

The above rheological properties enable the inkjet marking fluid to produce small (down to 3 picoliter) droplets to give high resolution. At the same time, the combination of the high viscosity and surface tension of dispersions restricts spreading of the inkjet marking fluid on the high surface-energy face of the hydrophilic plate. Thus the particle dot size in the image may be controlled by a suitable combination of marking fluid properties, especially by controlling the viscosity of the marking fluid.

In yet another embodiment of the method of the present invention, a significant improvement to the resolution of the image formed by the marking fluid can be obtained by coating the surface of the printing plate with a cationic surfactant solution and drying the solution prior to jetting marking fluid onto the plate. The surface of a substrate, bare anodized aluminum with no precoating (such as polymeric binder that should be washed away) is coated with a very thin layer (almost monomolecular) of cationic surfactants which is water repellent and insoluble in the inkjet marking fluid. The plate is then imaged using an inkjet printing head providing an excellent image quality and a strong stable oleophilic image from which to print high numbers of good quality impressions.

In this embodiment of the method of the present invention, no curing by actinic light is required and no processing of the imaged plate is needed. After imaging and drying, the plate can be placed directly on an offset plate cylinder and the coating is easily removed in the background areas by the fountain solution without affecting the image.

In this preferred embodiment, the cationic surfactant coating is an ammonium solution of primary (1°), secondary (2°), tertiary (3°), or quaternary (4°) long-chain hydrocarbon amines, i.e., comprised of more than 7 carbons in the chain. The amount of the cationic surfactant comprising the active component should be not more than 5% and not less then 0.01%. It is preferable in the range of 0.075-0.1% by weight (see Table 1 for examples).

Suitable cationic surfactants are those composed of not less than 7 carbon alkyl chains selected from the following general types: long-chain amines; diamines, polyamines, and their salts; quaternary ammonium salts; and long-chain amine oxides.

While the presence of the cationic surfactant is the heart of the formulation, it has been found that the following constituents in the defined proportions enhance performance. These include inorganic and water soluble organic acids, water-soluble glycols, and water soluble alcohols. The amount of acid added to the coating solution should give acidic pH of less then 6.5, and is preferable in the range of pH 2 to 3. The amount of water-soluble glycol added should be not more than 10% and it is preferably in the range of 2 to 5%. The amount of water-soluble alcohol should not exceed 95% and it is preferably in the range of 10 to 20%. If using only alcoholic solution, no addition of acid is necessary.

Table 1 gives select examples of the prepared coating solution, in accordance with a preferred embodiment of the present invention, which were made up under constant conditions of commercially-available uncoated, post-anodized, bushed, and electrochemically-grained aluminum plate and using inkjet marking fluid with a viscosity of 7.8 centipoise in a CTP system as described in the present invention. All examples are by weight.

TABLE 1
Examples of Coating Solutions

| | Surfactant Solution | Other | | De-ionized | Acid | |
|---|---|---|---|---|---|---|
| No. | 0.1% | Ingredients | % | Water (%) | Ingredient | pH |
| 1. | octylamine (Aldrich) | propylene | 4.9 | 95 | phosphoric | 2-3 |
| | | glycol | | | | |
| 2. | nonylamine (Aldrich) | propylene | 4.9 | 95 | phosphoric | 2-3 |
| | | glycol | | | | |
| 3. | decylamine | propylene | 4.9 | 95 | phosphoric | 2-3 |
| | (Aldrich) | glycol | | | | |
| 4. | undecylamine | propylene | 4.9 | 95 | phosphoric | 2-3 |
| | (Aldrich) | glycol | | | | |
| 5. | dodecylamine | propylene | 4.9 | 95 | phosphoric | 2-3 |
| | (Aldrich) | glycol | | | | |
| 6. | octadecylamine | propylene | 4.9 | 95 | phosphoric | 2-3 |
| | (Aldrich) | glycol | | | | |
| 7. | cetyltrimethyl- | propylene | 4.9 | 95 | phosphoric | 2-3 |
| | ammonium bromide | glycol | | | | |
| | (Aldrich) | | | | | |
| 8. | cetyltrimethyl- | propylene | 4.9 | 95 | (none) | — |
| | ammonium bromide | glycol | | | | |
| | (Aldrich) | | | | | |
| 9. | trihexylamine | propylene | 4.9 | 95 | phosphoric | 2-3 |
| | (Aldrich) | glycol | | | | |
| 10. | hyamine 2309 | propylene | 4.9 | 95 | phosphoric | 2-3 |
| | (Lonza BDH) | glycol | | | | |
| 11. | undecylamine | propylene | 4.9 | 95 | nitric | 2-3 |
| | (Aldrich) | glycol | | | | |
| 12. | undecylamine | propylene | 4.9 | 95 | hydrochlor | 2-3 |
| | (Aldrich) | glycol | | | ic | |
| 13. | undecylamine | propylene | 4.9 | 95 | acetic | 3-4 |
| | (Aldrich) | glycol | | | | |
| 14. | undecylamine | ethylene | 4.9 | 95 | phosphoric | 2-3 |
| | (Aldrich) | glycol | | | | |
| 15. | undecylamine | (none) | — | 99.9 | nitric | 2-3 |
| | (Aldrich) | | | | | |
| 16. | undecylamine | propylene | 3.0 | (none) | phosphoric | — |
| | (Aldrich) | glycol | 96.9 | | (12 μl) | |
| | | + ethanol | | | | |
| 17. | undecylamine | propylene | 4.9 | 74.9 | phosphoric | — |
| | (Aldrich) | glycol | 20.0 | | (12 μl) | |
| | | + ethanol | | | | |
| 18. | 1-hexadecylamine | propylene | 3 | (none) | phosphoric | — |
| | (Aldrich) | glycol | 96.9 | | (12 μl) | |
| | | + ethanol | | | | |
| 19. | N,N-dimethyl- | propylene | 3 | (none) | phosphoric | — |
| | dodecylamine | glycol | 96.9 | | (12 μl) | |
| | (Aldrich) | + ethanol | | | | |
| 20. | merisityl-trimethyl- | propylene | 3 | (none) | phosphoric | — |
| | ammonium bromide | glycol | 96.9 | | (12 μl) | |
| | (Aldrich) | + ethanol | | | | |
| 21. | N,N-dimethylun- | propylene | 3 | (none) | phosphoric | — |
| | decylamine | glycol | 96.9 | | (12 μl) | |
| | (Aldrich) | + ethanol | | | | |
| 22. | N-methyl- | propylene | 3 | (none) | phosphoric | — |
| | dodecylamine | glycol | 96.9 | | (12 μl) | |
| | (Aldrich) | + ethanol | | | | |
| 23. | dodecyltrimethyl- | propylene | 3 | (none) | phosphoric | — |
| | ammonium bromide | glycol | 96.9 | | (12 μl) | |
| | (Aldrich) | + ethanol | | | | |
| 24. | N-methyl- | propylene | 3 | (none) | phosphoric | — |
| | octadecylamine | glycol | 96.9 | | (12 μl) | |
| | (Aldrich) | + ethanol | | | | |
| 25. | didecylamine | propylene | 3 | (none) | phosphoric | — |
| | (Aldrich) | glycol | 96.9 | | (12 μl) | |
| | | + ethanol | | | | |
| 26. | laurilamine oxide | propylene | 3 | (none) | phosphoric | — |
| | (Galaxy) | glycol | 96.9 | | (12 μl) | |
| | | + ethanol | | | | |
| 27. | bezalkoniume | propylene | 3 | (none) | phosphoric | — |
| | chloride | glycol | 96.9 | | (12 μl) | |
| | (Galaxy) | + ethanol | | | | |
| 28. | 1.10-diamino- | propylene | 3 | (none) | phosphoric | — |
| | decane | glycol | 96.9 | | (12 μl) | |
| | (Aldrich) | + ethanol | | | | |
| 29. | 1,12-diamino | propylene | 3 | (none) | phosphoric | — |
| | dodecane | glycol | 96.9 | | (12 μl) | |
| | (Aldrich) | + ethanol | | | | |
| 30. | undecylamine* | propylene | 4.9 | 95 | phosphoric | 2-3 |
| | (Aldrich) | glycol | | | | |

*The % varies. See Table 2 for details.

Table 2 summarizes the dot size measured from coated plates that were coated with different coating concentrations of undecylamine.

TABLE 2
Summary of Dot Diameter Measurements
from Plates Coated with Different Concentrations of Undecylamine
(Including other ingredients as specified in Ex. 30 from Table 1)

| | Undecylamine [% w/w] | Dot Diameter [μm] |
|---|---|---|
| Ex. 30A | 0.005 | 115 |
| Ex. 30B | 0.01 | 85 |
| Ex. 30C | 0.015 | 85 |
| Ex. 30D | 0.025 | 55 |
| Ex. 30E | 0.05 | 52 |
| Ex. 30F | 0.1 | 50 |

For each of Examples 1-29, a grained, anodized aluminum plate was immersed in a coating solution comprising 0.1% of the surfactant solution and the percentages of other ingredients, as shown in Table 1. For Example 30, the coating solution comprised the proportions of ingredients as given in Example 4 in Table 1, except that variable amounts of undecylamine were used, as shown in Table 2.

The plate was dried for 1 minute at 70° C. and was then placed on an XY bed where it was imaged, in 600 dpi resolution, using the fluid and method of the present invention. The plate was then coated with acidified gum Arabic solution and placed on a Heidelberg GTO printing machine where 50,000 good impressions were printed on high quality coated paper.

Table 3 summarizes the dot size as measured from coated plates which were coated as specified in the examples given in Table 1.

TABLE 3
Summary of Dot Diameter Measurements
from Plates Coated with Various Coating Solutions
(as Specified in Table 1)

| Example Number | Dot Diameter [μm] |
|---|---|
| Uncoated plate | 100 |
| 1 | 75-80 |
| 2 | 60 |
| 3 | 60 |
| 4 | 50-55 |
| 5 | 55 |
| 6 | 60 |
| 7 | 60 |
| 8 | 50 |
| 9 | 95 |
| 10 | 65 |
| 11 | 60 |
| 12 | 45-50 |
| 13 | 55 |
| 14 | 50 |
| 15 | 55 |
| 16 | 55 |
| 17 | 55 |
| 18 | 55 |
| 19 | 55 |
| 20 | 60 |
| 21 | 65 |
| 22 | 55 |
| 23 | 65 |
| 24 | 55 |
| 25 | 55 |
| 26 | 60 |
| 27 | 55 |
| 28 | 60 |
| 29 | 60 |

The above Tables show the relationship between the cationic surfactant concentration (and as a result its surface concentration) and the dot size on a commercially available, brush-grained, anodized and post-anodized, treated aluminum offset plate coated in accordance with the method of the present invention.

It is possible to further improve the abrasion resistance of the jetted image to increase run length by means of injecting various forms of energy. This may be done by heating the image-bearing printing plate up to approximately 2000° C. to increase the cross-linking density of the polymer. In the preferred embodiment, the imaged printing plate is heated to a temperature between 100-140° C. Alternatively, curing is done by exposure of the imaged plate to UV light when the composition of the inkjet marking fluid is based on photosensitive monomers or oligomers in conjunction with photoinitiators.

The inkjet printing system cm operate on its own, functioning solely as a plate-maker, or it can be incorporated directly into a lithographic printing press. In the latter case, printing may commence immediately after application of the image to a blank plate and drying, thereby reducing press setup time considerably. The inkjet imaging system can be configured either as a flatbed printing system or as a cylinder printing system wherein the lithographic plate blank is mounted on the flatbed or attached to the exterior of the cylindrical surface.

In another embodiment of the method of the present invention, the inkjet marking fluid is deposited directly onto an erasable cylinder in an offset printing press which serves as the printing surface in a plateless system.

The following are examples of preferred embodiments of the inkjet marking fluid used in the printing process of the present invention in which all parts are given by weight.

### EXAMPLE 1

An inkjet marking fluid consisting of 7 parts of acrylic polymer emulsion, sold under the trade name of Joncryl 538 by S. C Johnson, 12 parts of Ethylenglycol, 1 part of di-propyleneglycol-monomethylether (D)PM), 1 part of black pigment sold under the trade name of Hostafine Black Ts by Clariant GmbH (or magenta Dye sold under the trade name of Bayscript Magenta by BAYER) and 12 parts of

water, was prepared. A 200 micron thick grained anodized aluminum plate was then placed on an XY bed where it was imaged (600 dpi image) using the inkjet printhead described in EP640481 assigned to Scitex using the above liquid. The plate was then heated to 140° C. for 2 minutes and then mounted on a Heidleberg GTO printing machine where 50,000 good impressions were printed on high-quality coated paper.

### EXAMPLE 2

An inkjet marking fluid consisting of 7 parts of acrylic polymer emulsion, sold under the trade name of Joncryl 537 by S. C Johnson, 12 parts of Ethylenglycol, 1 part of DPM, 1 part of black pigment sold under the trade name of Hostafine Black TS by Clariant GmbH (or magenta Dye sold under the trade name of Bayscript Magenta by BAYER) and 13 parts of de-ionized water, was prepared. Imaging, heat treatment, and testing were performed as described in Example 1. This process gave results similar to those reported in Example 1.

### EXAMPLE 3

An inkjet marking fluid consisting of 7 parts of acrylic emulsion, sold under the trade name of Joncryl 2177 by S. C Johnson, 12 parts of Ethylenglycol, 1 part of black pigment sold under the trade name of Hostafine Black TS by Clariant GmbH (or magenta Dye sold under the trade name of Bayscript Magenta by BAYER) and 13 parts of de-ionized water, was prepared. Imaging, heat treatment, and testing as described in Example 1 gave results similar to those reported there.

### EXAMPLE 4

An inkjet marking fluid consisting of 7 parts of acrylic emulsion polymer, sold under the trade name of Lucidene 366 by Morton, 12 parts of Ethylenglycol, 1 part of black pigment sold under the trade name of Hostafine Black TS by Clariant GmbH (or magenta Dye sold under the trade name of Magenta Bayscript by BAYER) and 14 parts of de-ionized water, was prepared. Imaging, heat treatment, and testing as described in Example 1 gave results similar to those in Example 1.

### EXAMPLE 5

An inkjet marking fluid consisting of 8 parts of acrylic emulsion polymer, sold under the trade name of Lucidene 388 by Morton, 12 parts of Ethylenglycol, 1 part of black pigment sold under the trade name of Hostafine Black TS by Clariant GmbH (or magenta Dye sold under the trade name of Magenta Bayscript by BAYER) and 13 parts of de-ionized water, was prepared. Imaging, heat treatment and testing as described in Example 1 gave results similar to those in Example 1.

### EXAMPLE 6

An inkjet marking fluid consisting of 11 parts of styren/acrylic emulsion polymer, sold under the trade name of Lucidene 410 by Morton, 12 parts of Ethylenglycol, 1 part of DPM, 1 part of black pigment sold under the trade name of Hostafine Black TS by Clariant GmbH (or magenta Dye sold under the trade name of Magenta Bayscript by BAYER) and 9 parts of de-ionized water, was prepared. Imaging, heat treatment, and testing as described in Example 1 gave results similar to those in Example 1.

### EXAMPLE 7

An inkjet marking fluid consisting of 7 parts of styrene/acrylic emulsion polymer, sold under the trade name of Lucidene 5025 by Morton, 12 parts of Ethylenglycol, 1 part of black pigment sold under the trade name of Hostafine Black TS by Clariant GmbH (or magenta Dye sold under the trade name of Magenta Bayscript by BAYER) and 13 parts of de-ionized water, was prepared. Imaging, heat treatment, and testing as described in Example 1 gave results similar those reported in Example 1.

### EXAMPLE 8

An inkjet marking fluid consisting of 6 parts of vinylidene chloride acrylic copolymer emulsion, sold under the trade name of Permax 801 by B F-Goodrich, 12 parts of Ethylenglycol, 1 part of black pigment sold under the trade name of Hostafine Black TS by Clariant GmbH (or magenta Dye sold under the trade name of Magenta Bayscript by BAYER) and 13 parts of de-ionized water, was prepared. Imaging, heat treatment, and testing as described in Example 1 gave results similar to those in Example 1.

### EXAMPLE 9

An inkjet marking fluid consisting of 10 parts of aliphatic urethane polymer dispersion, sold under the trade name of Sancure 776 by B F-Goodrich, 0.6 parts from the polymer dispersion solids of the photoinitiator Melamine, 12 parts of Ethylenglycol, 1 part of black pigment sold under the trade name of Hostafine Black TS by Clariant GmbH (or magenta Dye sold under the trade name of Bayscript Magenta by. BAYER) and 11 parts of de-ionized water, was prepared. Imaging, heat treatment, and testing as described in Example 1 gave results similar to those in Example 1. The plate can be cured in order to give extra abrasion resistance by crosslinking the polymeric system.

### EXAMPLE 10

An inkjet marking fluid consisting of 10 parts of aliphatic urethane polymer dispersion, sold under the trade name of Sancure 850 by B F-Goodrich, 0.6 parts from the polymer dispersion solids of the photoinitiator sold under the trade name Quantacure ITX by Biddle Sawyar, 12 parts of Ethylenglycol, 1 part of black pigment sold under the trade name of Hostafine Black TS by Clariant GmbH (or magenta dye sold under the trade name of Magenta Bayscript by BAYER), and 11 parts of de-ionized water, was prepared. Imaging, heat treatment, and testing as described in Example 1 gave results similar to those in Example 1. The plate can be UV-cured in order to give extra abrasion resistance by crosslinking the polymeric system.

### EXAMPLE 11

This Example most-clearly demonstrates the relationship between the viscosity of the inkjet marking fluid and the dot size on a commercially-available, brush-grained and post-anodic treated, uncoated aluminum offset plate.

An inkjet marking fluid consisting of variable parts of acrylic polymer emulsion, sold under the trade name of Joncryl 538 by S. C Johnson and other components as described in Example 1 was prepared and imaged.

Table 4 shows the dot diameter (in microns) obtained by using the inkjet marking fluid of Example 11 at different viscosities.

TABLE 4

| | Joncryl 538 | Viscosity | Dot Diameter |
|---|---|---|---|
| | Amount [parts] | [cP] | [μm] |
| Ex. 11A | 1.4 | 3.5 | 225 |
| Ex. 11B | 7 | 5.7 | 125 |
| Ex. 11C | 10.5 | 7.9 | 90 |
| Ex. 11D | 14 | 13.5 | 75 |

### EXAMPLE 12

This Example demonstrates the relationship between the viscosity of the inkjet marking fluid and the dot size on a commercially-available, brush-grained and post-anodic-treated, uncoated aluminum offset plate.

An inkjet marking fluid consisting of variable parts of aliphatic urethane polymer dispersion, sold under the trade name of Sancure 850 by B F-Goodrich and other components as described in Example 10, was prepared and imaged.

Table 5 shows the dot diameter (in microns) obtained by using the above-described inkjet marking fluid with different viscosities.

TABLE 5

| | Sancure 850 | | |
|---|---|---|---|
| | Amount | Viscosity | Dot Diameter |
| | [parts] | [cP] | [μm] |
| Ex. 12A | 4.8 | 3.3 | 250 |
| Ex. 12B | 9.6 | 4.1 | 175 |
| Ex. 12C | 14.5 | 7.8 | 100 |
| Ex. 12D | 19.3 | 12.6 | 65 |

Having described the present invention with regard to certain specific embodiments thereof, it is to be understood that the description is not meant as a limitation, since further modifications may now suggest themselves to those skilled in the art, and it is intended to cover such modifications as fall within the scope of the appended claims.

1. A method for the direct CTP preparation of printing plates, said method comprising the steps of:
providing a cationic surfactant coating solution on a printing surface comprising an active component and an inactive component;
providing a digital image by means of a computer system;
providing an inkjet marking fluid;
jetting said marking fluid onto said printing surface using an inkjet printing device; and
fixing said marking fluid on said printing surface.

2. The method as claimed in claim 1, including the further step of applying a very thin, almost monomolecular, layer of said coating solution onto said printing surface.

3. The method as claimed in claim 2, wherein said coating solution is applied directly to said printing space by immersion.

4. The method as claimed in claim 2, wherein said coating solution is applied directly to a cylinder substrate in a lithographic printing press comprising a plateless system.

5. The method as claimed in claim 2, including a further step wherein said coating solution is dried onto said printing surface by the application of heat.

6. The method as claimed in claim 5, wherein said heat is applied for about 1 minute at a temperature of about 70° C.

7. The method as claimed in claim 2, further including the step of treating said printing surface with acidic gum Arabic solution prior to commencing printing.

8. The coating solution as claimed in claim 1, wherein said active component comprises a primary (1°), secondary (2°), tertiary (3°), or quaternary (4°) long-chain hydrocarbon amine having more than 7 carbons in the chain.

9. The coating solution as claimed in claim 1, wherein said active component is selected from the group comprising long chain amines, diamines and polyamines, salts of diamines and polyamines, quaternary ammonium salts, and long chain amine oxides.

10. The coating solution as claimed in claim 1, wherein said active component is provided in an amount of not more than 0.5% and not less an 0.01% by weight.

11. The coat solution as claimed in claim 1, wherein said active component is provided in the amount of between 0.075-0.1% by weight.

12. The coating solution as claimed in claim 1, wherein said inactive component comprises combinations selected from the group comprising inorganic and water-soluble organic acids; water-soluble glycols; and water-soluble alcohols.

13. The coating solution as claimed in claim 12, wherein said organic acids have a pH of less than 6.5.

14. The coating solution as claimed in claim 13, wherein said organic acids have a pH in the range of 2 to 3.

15. The coating solution as claimed in 12, wherein said inactive component comprises not more than 10% by weight of water-soluble glycol.

16. The coating solution as claimed in claim 15, wherein said inactive component comprises 2-5% by weight of water-soluble glycol.

17. The coating solution as claimed in claim 12, wherein said inactive component comprises no more than 95% of water-soluble alcohol.

18. The coating solution as claimed in claim 17, wherein said inactive component comprises 10 to 20% by weigh of water-soluble alcohol.

19. The coating solution as claimed in claim 12, wherein said inactive component comprises only water-soluble alcohol.

20. The method as claimed in claim 1, wherein said inkjet marking fluid is provided having a pro-selected viscosity, said inkjet marking fluid comprising a two-phase emulsion system having an oleophilic inner phase and a continuous, aqueous, external phase.

21. The marking fluid as claimed in claim 20, wherein said inner phase comprises any combination of a resin dispersion in water.

22. The marking fluid as claimed in claim 20, wherein said inner phase comprises a binder constituting between 7-20% by weight of the liquid medium in said marking fluid.

23. The marking fluid as claimed in claim 20, wherein said inner phase is characterized by a particulate size of between 4 nm-3 microns.

24. The marking fluid as claimed in claim 20, wherein said marking fluid has a viscosity between 2-40 centipoise.

25. The marking fluid as claimed in claim 20, wherein said marking fluid has a surface tension within the range of 28-60 dyne/cm.

26. The marking fluid as claimed in claim 21, wherein said dispersion consists of a polymer selected from the group comprising: urethanes, acrylates, methacrylates, styrene, ethylene, butadiene, vinyl chloride, vinylidene chloride, vinyl acetate and other vinyl esters or copolymers of these materials and mixtures thereof.

27. The marking fluid as claimed in claim 21, where said dispersion comprises photosensitive monomers or oligomers combined with photoinitiators, wherein upon exposure to UV light, said marking fluid is cured onto said printing plate.

28. The mark fluid as clamed in claim 21, further comprising humectants, dyes, pigments, co-solvents, and coalescing agents.

29. The marking fluid as claimed in claim 28, wherein said humectants are selected from the group comprising glycols, glycol ethers, N-methylpirrolidone, substituted pirrolidone,

30. The marking fluid as claimed in claim 28, wherein sad dyes comprise less than 15% concentration by weight of carbon black.

31. The marking fluid as claimed in claim 28, wherein said pigments comprise less than 15% concentration by weight of carbon black.

32. The making fluid as claimed in claim 28, wherein said coalescing agents are selected from the group comprising glycol ethers, glycol acetates, and butyl carbitol.

33. The method as claimed in claim 1, wherein said printing surface is hydrophilic.

34. The method as claimed in claim 1, wherein said printing surface is a printing plate.

35. The method as claimed in claim 34, wherein said printing plate is comprised of at least one of a grained, anodized aluminum substrate and a polyester plate.

36. The method as claimed in claim 34, further comprising incorporating said printing plate into an offset lithographic printing press system.

37. The method as claimed in claim 36, wherein said printing press system is a lithographic printing flatbed system.

38. The method as claimed in claim 36, wherein said printing press system is an offset lithographic cylinder-plate system.

39. The method as claimed in claim 1, wherein said fixing of said marking fluid on sad printing surface is doe by curing by exposure to UV light.

40. The method as claimed in claim 1, wherein said fixing of said marking fluid on said printing surface is done by drying by thermal processing.

41. The method as claimed in claim 40, wherein said thermal processing is done by heating of said printing surface to a temperature between 100-140° C.

42. The method as claimed in claim 1, wherein said inkjet printing device comprises a drop-on-demand system.

43. The method as claimed in claim 1, wherein said inkjet printing device comprises a continuous system.

44. The method as claimed in claim 1, wherein said printing surface is a plateless, lithographic press cylinder.

45. The method as clamed in claim 1, wherein said printing surface is a plateless, flat-bed lithographic press.

46. A method for the direct CTP preparation of printing plates, said method comprising the steps of:
providing a cationic surfactant coating solution on a printing surface comprising an active component and an inactive component;
providing a digital image by means of a computer system,
providing an inkjet marking fluid having a pre-selected viscosity, said inkjet marking fluid comprising a two-phase emulsion system having an oleophilic inner phase and a continuous, aqueous, external phase;
jetting said marking fluid onto said printing surface using an inkjet printing device; and
fixing said marking fluid on said printing surface.
